(19) United States
(12) Patent Application Publication
(10) Pub. No.: US 2023/0097664 A1
(43) Pub. Date: Mar. 30, 2023

(54) TECHNOLOGIES FOR USER EQUIPMENT RELAY DISCOVER

(71) Applicant: APPLE INC., Cupertino, CA (US)

(72) Inventors: Shu GUO, Beijing (CN); Dawei ZHANG, Cupertino, CA (US); Haijing HU, Cupertino, CA (US); Huarui LIANG, Beijing (CN); Sudeep MANITHARA VAMANAN, Munich (DE)

(73) Assignee: APPLE INC., Cupertino, CA (US)

(21) Appl. No.: 17/441,415

(22) PCT Filed: Feb. 18, 2021
(86) PCT No.: PCT/CN2021/076692

§ 371 Date: Sep. 21, 2021

(51) Int. Cl. H04W 40/22; H04W 40/24; H04W 8/00

(52) U.S. Cl. CPC H04W 40/22; H04W 40/246; H04W 8/005; H04W 88/04

(57) ABSTRACT

The present application relates to devices and components including apparatus, systems, and methods for direct discovery or solicitation messages that include indications of types of user equipment-to-network relays.

### BACKGROUND

Third Generation Partnership Project (3GPP) has ongoing work items related to providing signaling and architectural enhancements to support proximity-based services. Consideration of aspects to enhance user equipment (UE)-to-network relay functionality is needed.

### BRIEF DESCRIPTION OF THE DRAWINGS

FIG. 1 illustrates a network environment in accordance with some aspects.

FIG. 2 illustrates protocol stack connections for a Layer 3 UE-to-network relay in accordance with some embodiments.

FIG. 3 illustrates protocol stack connections for user-plane traffic for a Layer 2 UE-to-network relay in accordance with some embodiments.

FIG. 4 illustrates protocol stack connections for control-plane traffic for a Layer 2 UE-to-network relay in accordance with some embodiments.

FIG. 5 illustrates a signaling diagram in accordance with some embodiments.

FIG. 6 illustrates an operational flow/algorithmic structure in accordance with some aspects.

FIG. 7 illustrates another operational flow/algorithmic structure in accordance with some aspects.

FIG. 8 illustrates another operational flow/algorithmic structure in accordance with some aspects.

FIG. 9 illustrates a user equipment in accordance with some aspects.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various aspects. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

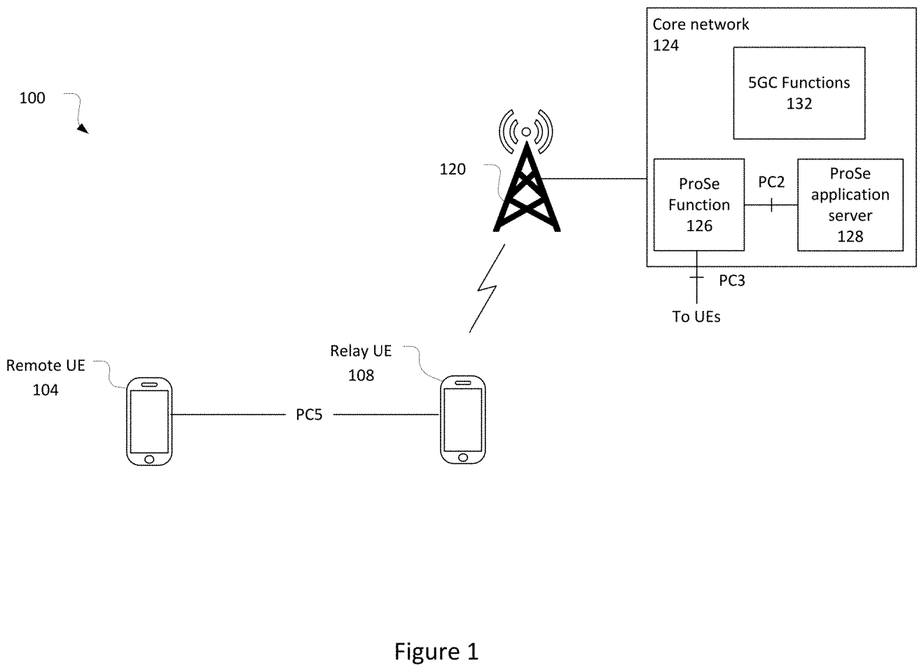

FIG. 1 illustrates a network environment 100 in accordance with some embodiments. The network environment 100 may include a plurality of UEs including, for example, a remote UE 104 and a UE-to-network relay UE 108 (or simply, “relay UE 108”). The UEs may operate in accordance with, or in a manner compatible to, Long Term Evolution (LTE), or Fifth Generation (5G) New Radio (NR) system standards as provided by 3GPP technical specifications.

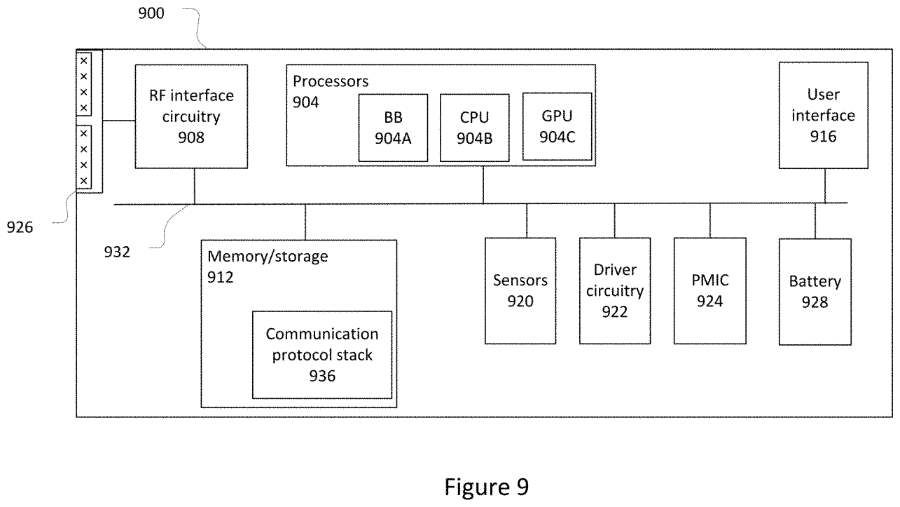

The UEs of the network environment 100 may be configured for proximity services (ProSe) communications in which the UEs may communicate directly with one another without the communications traversing through a base station 120 that provides a radio access network cell. The UEs may be mobile phones, consumer electronic devices, tablet computers, wearable computer devices (for example, smartwatches), vehicular computer devices, infrastructure equipment, sensors, or other devices such as described with respect to FIG. 9.

One or more of the UEs may communicate with the base station 120 that provides a wireless access cell, for example, an LTE cell or an NR cell. The base station 120 may be an evolved node B (eNB) providing an LTE access cell and being coupled with an evolved packet core (EPC) network; an ng-eNB providing an LTE access cell and coupled with a 5G core network (5GC); or a gNB providing an NR access cell and coupled with a SGC.

The base station 120 may be coupled with a core network 124, which may be an EPC or a SGC, to provide the UEs with services. The core network 124 may include network elements configured to offer various data and telecommunications services to customers/subscribers (for example, users of UEs) who are connected to the core network 124 via an access cell provided by the base station 120. The components of the core network 124 may be implemented in one physical node or separate physical nodes including components to read and execute instructions from a machine-readable or computer-readable medium (for example, a machine-readable storage medium). In some embodiments, network function virtualization (NFV) may be utilized to virtualize any or all of the above-described network node functions via executable instructions stored in one or more computer-readable storage mediums (described in further detail below). A logical instantiation of the core network 124 may be referred to as a network slice, and a logical instantiation of a portion of the core network 124 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more components/functions.

The core network 124 may include a ProSe function 126 that is a logical function used for network-related actions related to ProSe operations. The ProSe function 126 may interface with UEs through a PC3 interface and with a ProSe application server 128 through a PC2 interface.

The ProSe function 126 may control a direct provisioning function (DPF) used to provision a UE with necessary parameters in order to use ProSe direct discovery in ProSe direct communication. The DPF may provision UEs with public land mobile network (PLMN) specific parameters that allow the UE to use ProSe in a particular PLMN. The DPF may also provision a UE with parameters that may be used for direct communication when the UE is not served by radio access network cell. The ProSe function 126 may also include a direct discovery name management function for open ProSe direct discovery to allocate and process the mapping of ProSe applications identifiers and ProSe application codes used in ProSe direct discovery.

The ProSe application server 128 may store and manage various ProSe identifiers, metadata, and authorizations related to various discovery operations.

If the core network 124 is a SGC, it may include a number of 5GC functions 132 including, but not limited to, an access and mobility management function (AMF), a user plane function (UPF), a session management function (SMF), and a policy control function (PCF). The AMF may perform registration, reachability, connection, and mobility management functions. The UPF may be responsible for routing and forwarding user-user plane packets between the base station 120 and an external network. The SMF may perform protocol data unit (PDU) session management, IP address allocation, general packet radio service tunneling protocol-user plane (GTP-U) tunnel management, and downlink notification management. The PCF may provide policies associated with mobility and session management. These functions may be implemented in one or more servers or other devices in a centralized location or in distributed locations.

At a particular time, the UEs may be within or out of coverage of a radio access network cell provided by a base station such as base station 120. For example, at a given time the UEs of the network environment 100 may be in a full-coverage scenario (for example, all UEs are within cell coverage), partial-coverage scenario (for example, a subset of the UEs may be within cell coverage), or out-of-coverage scenarios (for example, no UEs are within cell coverage). Embodiments described herein may relate to the partial-coverage scenario in which the remote UE 104 is out of cell coverage while the relay UE 108 is in cell coverage.

When the remote UE 104 is out of range of the base station 120 it may seek to discover a UE-to-network relay (for example, relay UE 108) through which it may connect to the base station 120. The remote UE 104 may discover the relay UE 108 without the assistance of the base station 102 in a standalone discovery procedure. After the remote UE 104 discovers and selects the relay UE 108, the UEs may establish a direct connection with one another through a sidelink (SL) interface. An SL interface may alternatively be referred to as a ProSe interface, device-to-device (D2D) interface, or a PC5 interface or reference point. The relay UE 108 may relay unicast traffic between the remote UE 104 and the network, for example, base station 120. The relay UE 108 may provide a generic function that can relay any IP, Ethernet, or unstructured traffic.

Depending on the capabilities of the relay UE 108, it may relay communications at different layers of a protocol stack. For example, the relay UE 108 may be a Layer-2 (L2) relay or a Layer-3 (L3) layer. L2 and L3 relays may include different protocol stacks and security mechanisms. For example, an L3 relay may include an application layer security mechanism, while an L2 relay may not provide such a high-layer security mechanism.

In some instances, the remote UE 104 may not support the protocol stacks and security mechanisms for both L2 and L3 relays. In other instances, the remote UE 104 may support both protocol stacks/security mechanisms, but may have a preference for connecting through an L2 or L3 relay. This preference may be based on type of data to be communicated with the network, conditions of the network environment 100, etc. Thus, embodiments describe relay discovery and selection that provides the remote UE 104 with flexibility to connect to a desired relay type. In particular, embodiments of this disclosure teach differentiation of two types of relays in a standalone discovery procedure. When discovering a relay, the remote UE 104 may first determine a type of the relay (for example, L2 or L3 relay) before determining whether to connect with the relay.

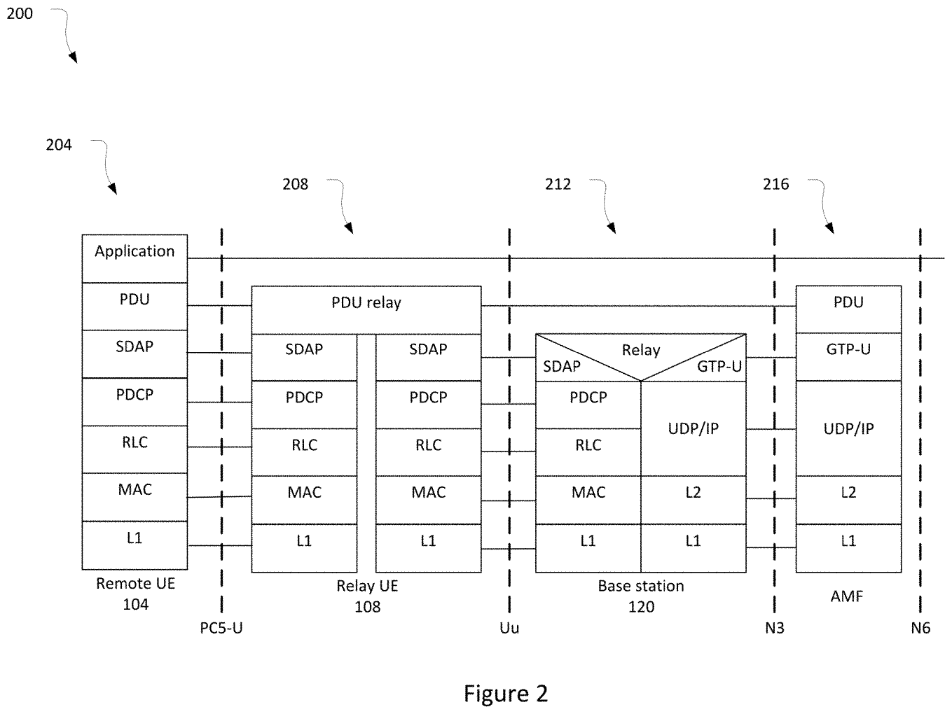

FIG. 2 illustrates protocol stack connections 200 in embodiments in which the relay UE 108 is an L3 relay. In particular, FIG. 2 illustrates a protocol stack 204 of the remote UE 104, protocol stacks 208 of the relay UE 108, protocol stacks 212 of the base station 120, and a protocol stack 216 of an AMF of the core network 124.

The protocol stack 204 may include layers coupled with respective layers of the protocol stacks 208 over a PC5-user plane (U) interface. The protocol stack 204 may include a Layer 1 (L1), a media access control (MAC) layer, a radio link control (RLC) layer, a packet data convergence protocol (PDCP) layer, a service data adaptation protocol (SDAP) layer, a PDU layer, and an application layer. The MAC, RLC, PDCP, and SDAP may be L2 layers (or sublayers), while the PDU layer may be an L3 layer.

The application layer may use lower layers to provide a data transfer service.

The PDU layer may process PDUs that are transported between the remote UE 104 and a packet data network (PDN) during a PDU session. A PDU session may be, for example, and Internet protocol v6 (IPv6) session type for transporting IP packets or an Ethernet session type for transmitting Ethernet frames.

The SDAP layer may perform operations such as mapping between quality of service (QoS) flows and data radio bearers and marking QoS flow identifiers in both downlink and uplink packets.

The PDCP layer may control transfer of user/control plane data, header compression, ciphering, and integrity protection.

The RLC layer may transfer upper layer protocol data units in an acknowledged mode, unacknowledged mode, or transparent mode. The RLC layers may manage RLC service data units and protocol data units separately for each of these modes to provide error detection and recovery.

The MAC layer may perform mapping between logical channels and transport channels for transmitter and receiver; multiplexing for a transmitter; demultiplexing for a receiver, scheduling information reporting for a transmitter; error correction through hybrid automatic repeat request (HARM) for a transmitter/receiver; logical channel prioritization for the transmitter; and radio resource selection for the transmitter.

The L1 layer, which may be referred to as a physical (PHY) layer, may provide physical layer processing as well as transmission and reception across a communication interface. The L1 layer may add cyclic redundancy check bits to transport blocks at a transmitter to allow error detection at a receiver. The L1 layer may also perform channel coding, interleaving, and modulation to efficiently transmit/receive information over the communication interface.

Layers within protocol stacks 208, 212, and 216 may operate in a similar manner to like-named layers in protocol stack 204.

The protocol stacks 208 may also include a PDU relay to relay traffic of a PDU session between PDU layers of protocol stack 204 and 216. In this example, the relay UE 108 may operate as an L3 relay given that it includes L3 processing of the traffic (for example, at the PDU layer). Processing the traffic at L3 may provide the relay UE 108 with additional capabilities. However, it may also be desired that the relay UE 108 is in a relatively secured and trusted relationship with the remote UE 104 given that the relay UE 108 may be capable of processing the traffic at the PDU layer and, therefore, has higher-layer visibility.

The protocol stacks 212 may include a relay that converts SDAP traffic to GTP traffic and vice versa. The protocol stacks 212 may include a GTP-U layer to carry user data between the base station 120 and the core network 124 via a GTP tunnel. The GTP-U may multiplex traffic from different PDU sessions into a tunnel for transmission over the N3 interface.

The protocol stacks 212 may further include a user datagram protocol (UDP)/IP that corresponds to the PDCP and RLC layers. The UDP/IP may provide transport/Internet layer operations consistent with a typical Internet protocol suite.

The protocol stacks of FIG. 2 may generally correspond to solution #6 as described in section 6.6 of 3GPP Technical Report (TR) 23.752, v1.0.0 (2020-11). In some embodiments, solution #6 may be used in the event the relay UE 108 is an entity that is trusted by the remote UE 104. In the event that the relay UE 108 is not a trusted entity, solution #23 of TR 23.752 may be used to provide end-to-end security for the remote UE 104.

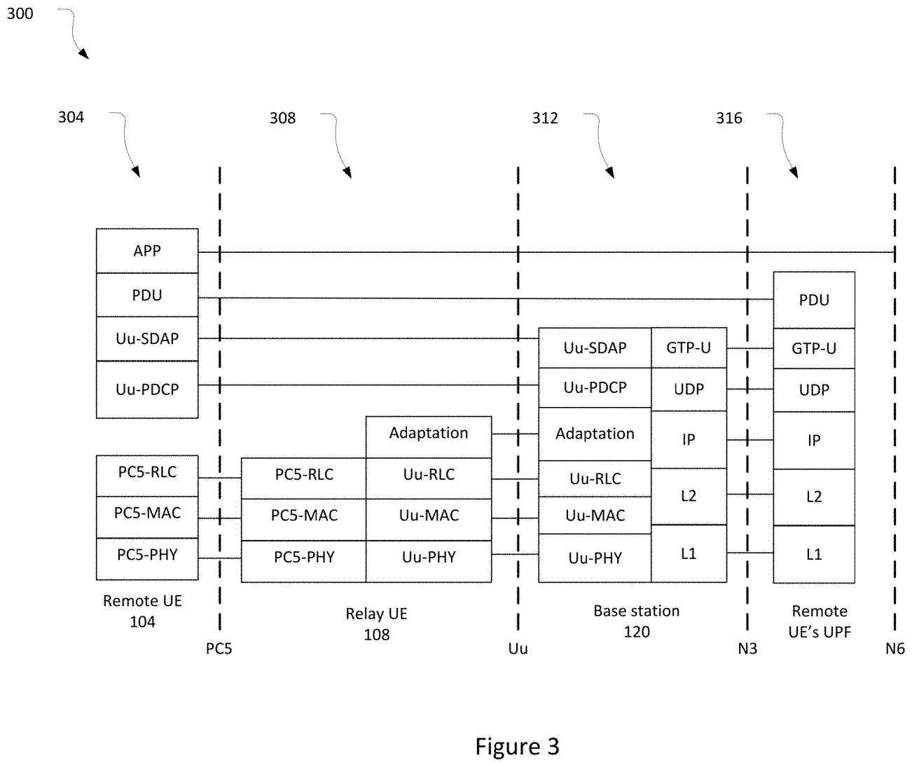

FIG. 3 illustrates example protocol stack connections 300 for user-plane traffic in embodiments in which the relay UE 108 is an L2 relay. In particular, FIG. 3 illustrates a protocol stack 304 of the remote UE 104, protocol stacks 308 of the relay UE 108, protocol stacks 312 of the base station 120, and a protocol stack 316 of the remote UE's UPF, which may reside in the core network 124.

The protocol stack 304 may include an application layer, a PDU layer, an SDAP layer, a PDCP layer, and RLC layer, a MAC layer, and a PHY layer. Unless otherwise described, these layers may be similar to those described above with respect to FIG. 2.

The PDU layer of protocol stack 304 may interface directly with a PDU layer in protocol stack 316. Thus, the protocol stacks 308 of the relay UE 108 may not include a PDU relay that processes the PDU traffic.

The SDAP and PDCP layers of the protocol stack 304 may interface directly, over the Uu interface, with corresponding SDAP and PDCP layers in protocol stacks 312 of the base station 120. Thus, these layers may be referred to Uu-SDAP or Uu-PDCP layers.

The RLC, MAC, and PHY layers of the protocol stack 304 may interface, over the PCS interface, with corresponding RLC, MAC, and PHY layers of the protocol stack 308. Thus, these layers may be referred to as PC5-RLC, PC5-MAC, or PC5-PHY layers.

The protocol stack 308 may further include RLC, MAC, and PHY layers configured to interface with corresponding layers of protocol stack 312 over a Uu interface. Thus, these layers may be referred to as Uu-RLC, Uu-MAC, or Uu-PHY layers.

The protocol stack 308 may further include an adaptation layer to interface with an adaptation layer of protocol stack 312 over the Uu interface. The adaptation layers may identify signaling radio bearers (SRBs) and data radio bearers (DRBs) for the remote UE 104. The adaptation layers may map PCS traffic to one or more DRBs of the Uu and vice versa.

In this example, the relay UE 108 may process traffic from the remote UE only up to L2 (for example, the RLC layer). Traffic at L3 and above will be tunneled between the remote UE 104 and the base station 120 or functions of the core network 124 and may, therefore, not be visible to the relay UE 108.

The protocol stacks 312 may further include a GTP-U layer, a UDP layer, and IP layer, an L2 layer, and an L1 layer that interface with corresponding layers of the protocol stack 316 over an N3 interface.

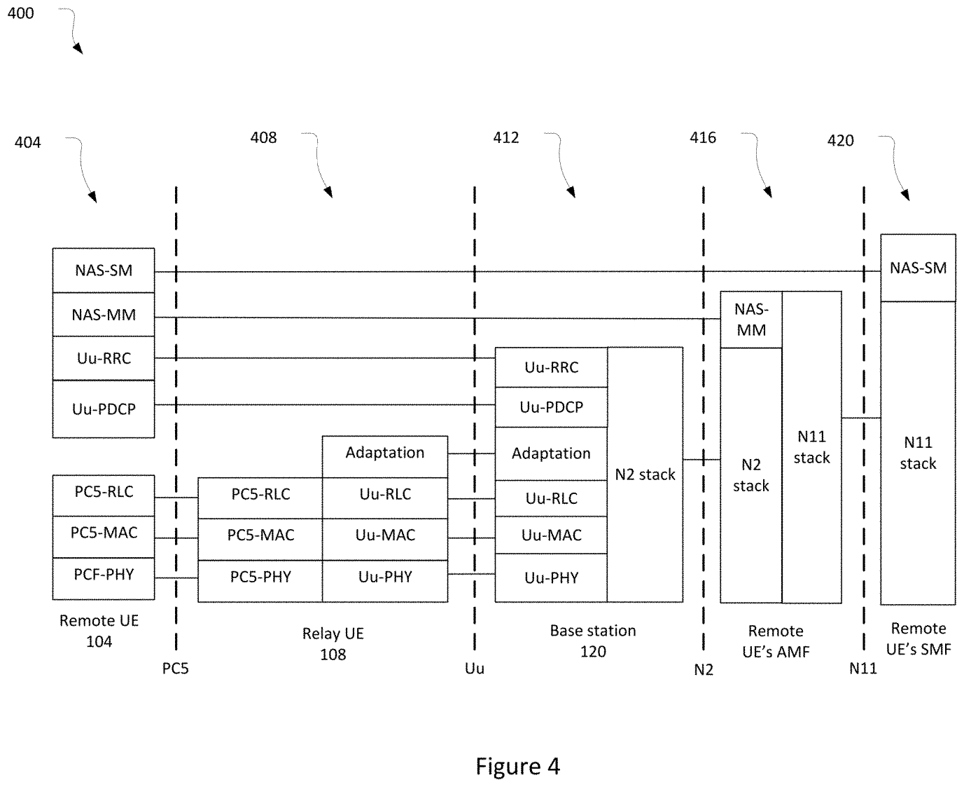

FIG. 4 illustrates example protocol stack connections 400 for control-plane traffic in embodiments in which the relay UE 108 is an L2 relay. In particular, FIG. 4 illustrates a protocol stack 404 of the remote UE 104, protocol stacks 408 of the relay UE 108, protocol stacks 412 of the base station 120, a protocol stack 416 of the remote UE's AMF, and a protocol stack 420 of the remote UE's SMF. The AMF and SMF may reside in the core network 124.

The remote UE 104 may have a non-access stratum (NAS) connection with the 5GC (for example, core network 124) that may be used for remote UE registration and connection establishment/management. These procedures may be similar to those described with respect to solution #7 of TR 23.752.

The protocol stack 404 may include a NAS-session management (SM) layer and a NAS mobility management (MM) layer that exchange NAS messages with corresponding layers of the protocol stacks 416 and 420. The NAS messages may be transparently transferred over the relay UE 108 using: a PDCP connection between Uu-PDCP layer of protocol stack 404 and Uu-PDCP layer of protocol stacks 412 over the Uu interface; an N2 connection between the NAS-MM layer of the protocol stack 404 and the NAS-MM layer of protocol stacks 416 over the N2 interface; and an N11 connection between the NAS-SM layer of protocol stack 404 and the NAS-SM layer of protocol stack 420 over the N11 interface. The two endpoints of the PDCP link are the remote UE 104 and the base station 120. Thus, the role of the relay UE 108 in the PDCP end-to-end connection is simply to relay the PDUs over the SRB without any modifications.

The protocol stacks 404, 408, 412 may include layers such as RRC layer, PDCP layer, an RLC layer, a MAC layer, and PHY layer. Unless otherwise described, these layers may be similar to those described above with respect to FIGS. 2 and 3. Layers communicating over the N2 interface, between the base station 120 and the AMF are generically referred to as N2 stack. Similarly, layers communicating over the N11 interface, between the AMF and the SMF, are generically referred to as N11 stack. The protocol stacks of FIGS. 3 and 4 may generally correspond to Annex A of TR 23.752.

As briefly mentioned above, a standalone discovery procedure may be used to discover an L2 or L3 relay. This may be used for commercial services or public safety messages. A PC5 communication channel may be used to carry a discovery message over a PC5 interface. The discovery message transmitted over the PC5 interface may be differentiated from other PC5 messages by an access stratum (AS) layer. Embodiments described herein provide enhancements for standalone direct discovery. These enhancements may be applied to solution #19 of TR 23.752 in accordance with some embodiments.

The standalone discovery procedure used to discover an L2 or L3 relay may be based on a model A or B procedure as described in section 5.3.1.2 of Technical Specification (TS) 23.303 v16.0.0 (2020-07-09).

The model A procedure, which may be referred to colloquially as the “I am here” procedure, may define two roles for ProSe-enabled UEs that are participating in ProSe direct discovery. A first role may be that of an announcing UE that announces certain information that could be used by UEs in proximity that have permission to discover. A second role may be that of a monitoring UE that monitors for certain information of interest in proximity of announcing UEs. In this model, the announcing UE may broadcast discovery message at predefined discovery intervals. The monitoring UEs that are interested in these messages may read and process them.

The model B procedure, which may be referred to colloquially as the “Who is there?/Are you there?” procedure, may also define two rules for the ProSe-enabled UEs that are participating in ProSe direct discovery. A first role may be that of a discoverer UE that transmits a request containing certain information about what is interested to discover. A second role may be that of a discoveree UE that receives the request message and can respond with some information related to the discoverer's request. Thus, the discoverer UE may send information about other UEs from which it would like to receive responses. For example, the information can be about a ProSe application identity corresponding to a group and the members of the group can respond.

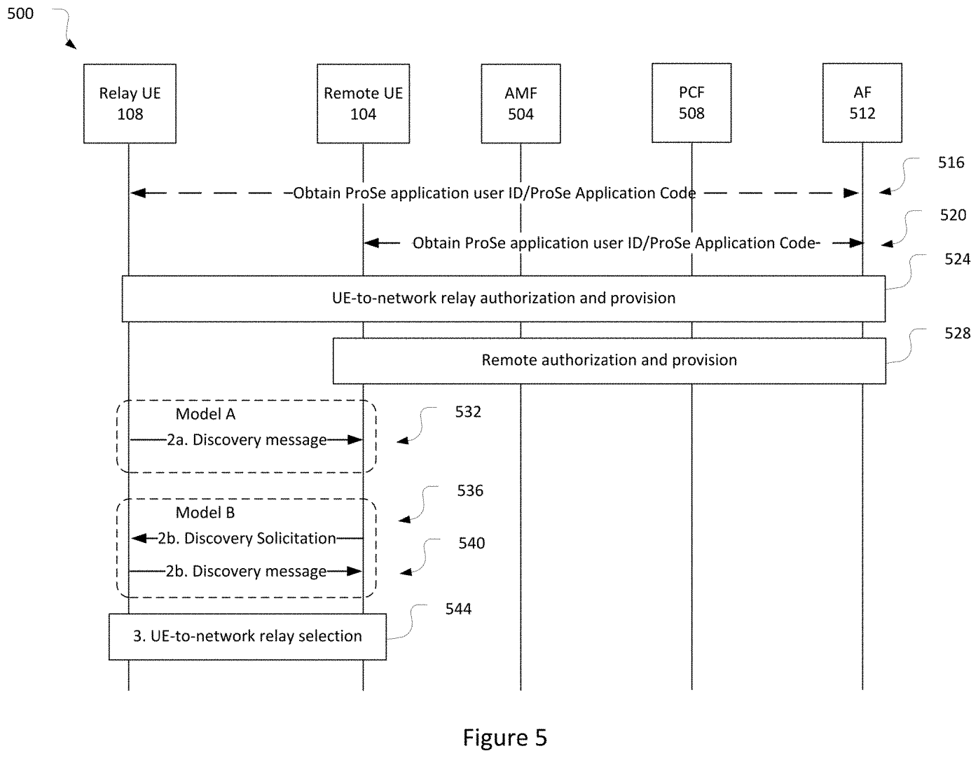

FIG. 5 illustrates a signaling diagram 500 in accordance with some embodiments. Except as otherwise described herein, the signaling diagram 500 may be similar to that described with respect to solution #19 in section 6.19 of TR 23.752.

The signaling diagram 500 may include various messages between the relay UE 108, the remote UE 104, and functions of the core network 124 including, for example, AMF 504 and PCF 508 (of 5GC functions 132) and application function 512, which may correspond to ProSe function 126 or ProSe application server 128.

At 516 and 520, the relay UE 108 and remote UE 104 may obtain ProSe application User IDs and ProSe application codes for ProSe direct discovery from the AF 512 using application layer mechanisms. An application layer in the respective UEs may initially provide an application user ID and an application ID to the AF 512. The AF 512 may then allocate and provide the ProSe application user ID and the ProSe application code to the application layer of the UEs.

At 524, the relay UE 108 may obtain authorization and provision to be a UE-to-network relay as defined for service authorization solutions. At 528, the remote UE 104 may obtain authorization and provision to be a remote UE as defined for service authorization solutions. Direct discovery authorization and provision for the remote UE 104 and the relay UE 108 may be accomplished by the AF 512 providing group or service information to the PCF 508, and the PCF 508 providing authorization to the respective UEs. The PCF 508 may provide information to the UEs based on information received from the AF 512 and local policy. The information may include service information (for example, an application identifier) to be directly discovered over a PC5 interface; group information (for example, an external group identifier) to be directly discovered over the PC5 interface; area information (for example, a geographical tracking area list) used for direct discovery over the PC5 interface; or security parameters used for direct discovery over the PC5 interface. In general, the procedures for authorization provision may be similar to those described in section 6.1.2.2 of TR 23.752 and the authorized parameters may be similar to that described in section 6.19.1.1 of TR 23.752.

In embodiments in which the UEs are configured for Model A UE-to-network discovery, the relay UE 108 may be triggered to generate and transmit a PC5 direct discovery message for announcement at 532. The triggering of the relay UE 108 to send the discovery message at 520 may be from, for example, an upper layer application, a user, or an announcement configuration setting. The discovery message may include relay related information such as, for example, service/application identifiers (IDs) or other information related to services and applications that are enabled or authorized to be relayed; group index(es) or other information related to groups for which the relay UE 108 may provide the relay service; slicing information (for example, one or more allowed single-network slice selection assistance information (S-NSSAI) regarding network slices for which the relay UE 108 is authorized or enabled to relay; data network name (DNN) information for DNN(s) the relay UE 108 is authorized to access; or home or visited public land mobile network (HPLMN or VPLMN) for the relay UE 108. The relay UE 108 may compute a security protection element for example, for integrity protection, and append the security protection element to the discovery message.

The remote UE 104 may be triggered by, for example, an upper layer application or a user, to discover a UE-to-network relay and may begin to monitor for a discovery message. After receiving the discovery message transmitted at 520, the remote UE 104 may determine whether to select the relay UE 108 to provide a UE-to-network relay connection at 544. In determining whether to select the relay UE 108 as the relay connection, the remote UE 104 may consider a PC5 radio condition for the relay UE 108; services that the relay UE 108 can relay; groups for which the relay UE 108 can provide relay service; possible DNNs/S-NSSAIs for the relay service; serving PLMN for the relay UE 108; and whether the remote UE 104 is preconfigured with the relay UE 108 as a provider for a relay connection. The remote UE 104 may also verify the security protection element using the provision security parameters corresponding to the application. If the remote UE 104 selects the relay UE 108 and verification of the security protection element is successful, the relay UE 108 may be successfully discovered by the remote UE 104 and may provide the relay connection.

In embodiments in which the UEs are configured for Model B UE-to-network discovery, the remote UE 104 (being authorized to operate as a remote UE and perform a discovery solicitation procedure) may be triggered to generate and transmit a discovery solicitation message at 536 to discover a UE-to-network relay for a relay related service. The triggering of the remote UE 104 to send the discovery solicitation message at 536 may be from, for example, an upper layer application or a user. The discovery solicitation message may include information of the discoverer ProSe UE ID and relay related information that provides information about a desired relay connection. The relay related information may include service/application IDs or other information related to services and applications that are to be relayed; group index(es) or other information related to groups for which the relay service is to be provided; slicing information (for example, one or more allowed S-NSSAI) regarding network slices for which information is to be relayed; DNN information for DNN(s) corresponding to the relay service. The remote UE 104 may also compute a security protection element (for integrity protection, for example) and append the security protection element to the discovery solicitation message transmitted at 536.

The relay UE 108 may receive the discovery solicitation message and determine whether it is able and authorized to respond based on information within the discovery solicitation message and previously configured information. For example, the relay UE 108 may determine whether it can provide the relay connection associated with the information in the discovery solicitation message. If the relay UE 108 is able/authorized to respond, the relay UE 108 may generate and transmit a discovery message at 540. The discovery message transmitted at 540 may include, for example, ProSe UE ID, service/application information, group index(es), S-NSSAI(s), DNN, HPLMN or VPLMN similar to that described above with respect to discovery message transmitted at 532.

The remote UE 104 may determine whether to select the relay UE 108 based on the information included in the discovery message. If the remote UE 104 selects the relay UE 108, and the security protection element is successfully verified, the remote UE 104 may proceed with the UE-to-network relay selection at 544.

In order to provide a relay type basis for relay discovery and selection, some embodiments provide that when the relay UE 108 is announcing to be a UE-to-network relay in Model A, it may include a relay type indication in, for example, a relay type information element (IE) in the discovery message generated and transmitted at 532. The relay type indication may indicate whether the relay UE 108 is an L2 relay or an L3 relay. When the remote UE 104 is monitoring discovery messages for connection, it may detect the relay type

IE and proceed accordingly. For example, the remote UE 104 may determine whether it supports the relay type indicated in the discovery message along with any other basis for determining whether the remote UE 104 is to select the relay UE 108 (such as those described above with respect to selection at 544). If the remote UE 104 determines that it supports the indicated relay type, and otherwise determines that it would like to select the relay UE 108, it may then proceed to verify the security protection element. If the remote UE 104 does not support the relay type indicated in the discovery message, the remote UE 104 may drop the announcement of the discovery message and may keep searching for other relays.

In a similar manner for Model B discovery, when the remote UE 104 is performing the discovery solicitation procedure, it may include indication of a relay type in a relay type IE in the discovery solicitation message generated and transmitted at 536. The relay type indication included in the discovery solicitation message may indicate whether the remote UE 104 is capable of connecting with (or desires to connect to) an L2 or an L3 relay. In some embodiments, the relay UE 108 may receive the discovery solicitation and determine whether it can provide the indicated relay type. If so, the relay UE 108 may proceed to transmit the responsive discovery message at 540. The discovery message transmitted at 540 may or may not include an indication of a relay type provided by the relay UE 108. Relay UEs that cannot provide the indicated relay type may not respond to the discovery solicitation message.

In various embodiments, the relay type indication in the relay type IE may include one or two bits. For a one-bit example, a ‘0’ may indicate the relay UE 108 is (or the remote UE 104 desires) an L2 relay (or L3 relay); and a ‘1’ may indicate the relay UE 108 is (or the remote UE 104 desires) an L3 relay (or L2 relay). For a two-bit example, ‘00’ may indicate the relay UE 108 is (or the remote UE 104 desires) an L2 relay (or L3 relay); ‘01’ may indicate the relay UE 108 is (or the remote UE 104 desires) L3 relay (or L2 relay); and ‘11’ may indicate the relay UE 108 is capable of supporting both relay types (or the remote UE 104 has no preference and is capable of connection with either relay type). For another two-bit example, ‘10’ may indicate the relay UE 108 is (or the remote UE 104 desires) an L2 relay (or L3 relay); ‘01’ may indicate the relay UE 108 is (or the remote UE 104 desires) L3 relay (or L2 relay); and ‘11’ may indicate the relay UE 108 is capable of supporting both relay types (or the remote UE 104 has no preference and is capable of connection with either relay type). Any permutation or combination of signaling relay type may be used in various embodiments.

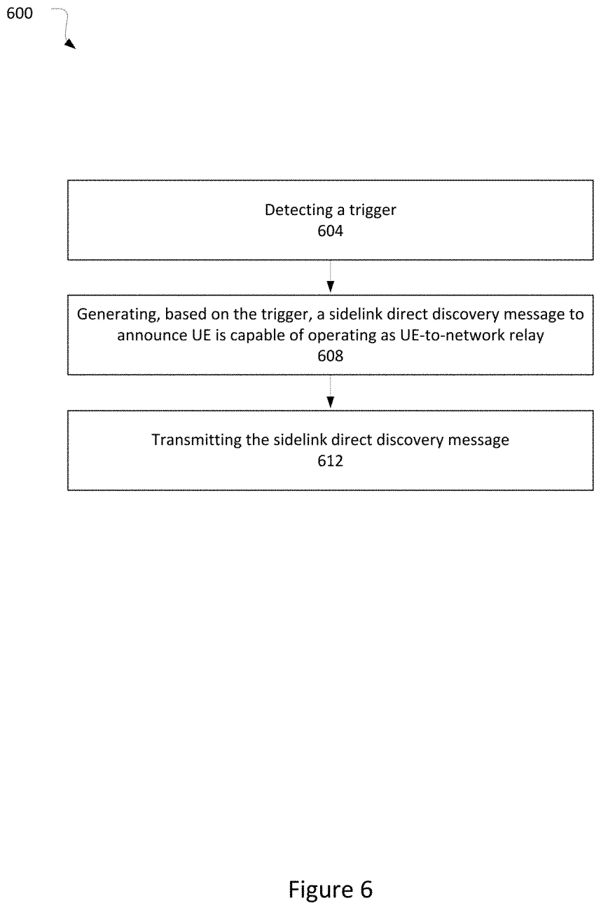

FIGS. 6-8 present a number of operation flows/algorithmic structures in accordance with embodiments of this disclosure. These operation flow/algorithmic structures describe a number of operations in a particular sequence. However, the presented sequences are not restrictive. That is, the operations may be performed in sequences other than those specifically presented.

FIG. 6 illustrates an operation flow/algorithmic structure 600 in accordance with some aspects. The operation flow/algorithmic structure 600 may be performed or implemented by a UE-to-network relay such as, for example, relay UE 108 or UE 900; or components thereof, for example, baseband processor circuitry 904A.

The operation flow/algorithmic structure 600 may be based on, or otherwise similar to, a Model A UE-to-network discovery process.

The operation flow/algorithmic structure 600 may include, at 604, detecting a trigger. The trigger may be from an upper layer application, a user of the UE, or an announcement configuration setting (from the AF 512, for example).

The operation flow/algorithmic structure 600 may further include, at 608, generating a sidelink direct discovery message to announce that the implementing UE is capable of operating as a UE-to-network relay. The generating of the direct discovery message may be based on the detection of the trigger.

The discovery message may be generated with an indication of the relay type of the implementing UE. For example, the indication may indicate that the implementing UE is to operate as an L2 relay or an L3 relay in order to provide the UE-to-network relay connection. The indication may be one or two bits within a relay type IE of the direct discovery message.

In addition to the indication of the relay type, the discovery message may include service and application information that is enabled or authorized to be relayed; group information for which the implementing UE can provide relay service; slicing information the implementing UE is enabled or authorized to relay; DNN information the implementing UE is authorized to access; or an HPLMN or VPLMN for the implementing UE.

The operation flow/algorithmic structure 600 may further include, at 612, transmitting the sidelink direct discovery message. The sidelink direct discovery message may be transmitted over a sidelink interface for reception by one or more remote UEs. A remote UE may respond to the direct discovery message to select the UE as a UE-to-network relay. This may be based on the relay type of the implementing UE and other information in the direct discovery message.

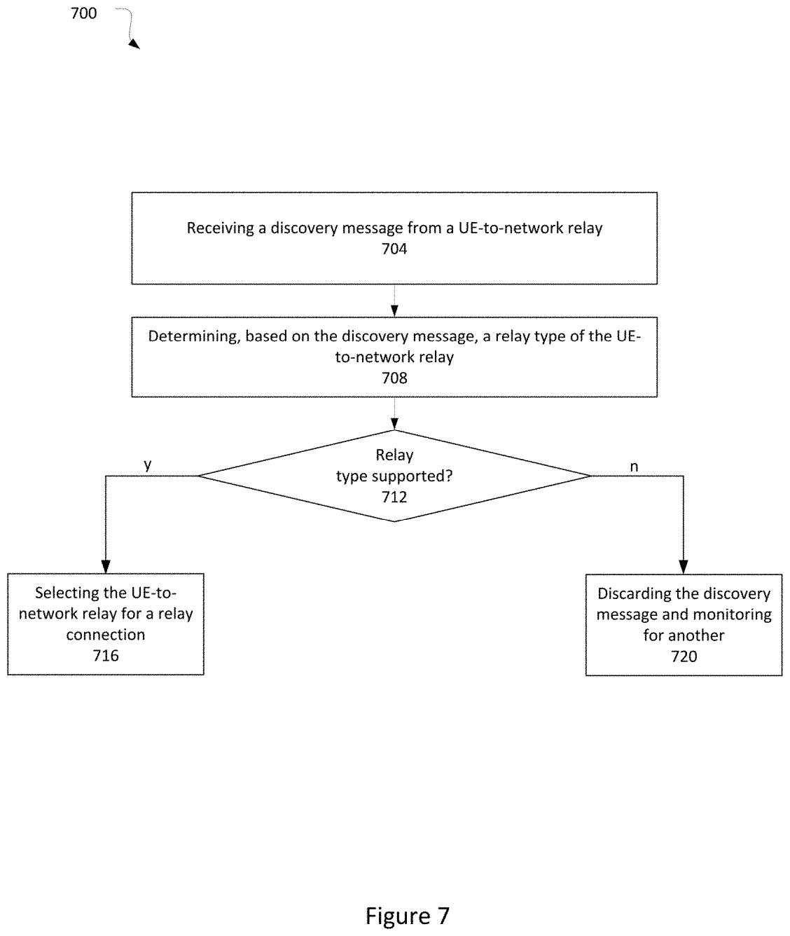

FIG. 7 illustrates an operation flow/algorithmic structure 700 in accordance with some aspects. The operation flow/algorithmic structure 700 may be performed or implemented by a remote UE such as, for example, remote UE 104 or 900; or components thereof, for example, baseband processor circuitry 904A.

The operation flow/algorithmic structure 700 may be based on, or otherwise similar to, a Model A UE-to-network discovery process.

The operation flow/algorithmic structure 700 may include, at 704, receiving a discovery message from a UE-to-network relay. The receiving of the discovery message may be based on the implementing UE being approved/authorized to operate as a remote UE and monitoring a sidelink channel for the discovery message. The received discovery message may be similar to that described above with respect to FIG. 5 or 6.

The operation flow/algorithmic structure 700 may further include, at 708, determining a relay type of the relay UE that transmitted the discovery message. The determining at 708 may be based on an explicit or implicit indication provided by the discovery message. An explicit indication may be a one or two bit value in a relay type IE of the discovery message that indicates whether the relay UE is to operate as an L2 or L3 relay.

An implicit indication may be based on parameter within the discovery message that is associated with, but does not directly indicate, a specific relay type. For example, the presence or absence of specific parameters within the discovery message may provide an indication of whether the relay type is to operate as an L2 or L3 relay. The parameters may include broadcast slicing information, DNN information, security information, or PDU session information that may implicitly indicate that the relay is to operate as an L3 relay. For example, broadcast slicing information or other PDU session information may not be required for an L2 relay in some instances (see, for example, solution #19 in TR 23.752). Thus, if the broadcast slicing information or other PDU session information is included, the remote UE may determine that the relay UE provides an L3 relay.

The operation flow/algorithmic structure 700 may further include, at 712, determining whether the relay type of the relay UE is supported. The implementing UE may access relay support information stored in memory of the implementing UE in order to determine whether it is capable of operating with an L2 or an L3 relay. The relay support information may be based on configuration (from AF 512, for example) or capability of the remote UE. In some embodiments, the relay support information may be based on a nature of the forthcoming connection, for example, a type of traffic that is to be transmitted over the relay connection.

If it is determined, at 712, that the relay type is supported, the operation flow/algorithmic structure 700 may advance to selecting the UE-to-network relay for the relay connection. In addition to being based on the relay type, the selection of the UE-to-network relay for the relay connection may be based on other considerations. These considerations may include, but are not limited to, a sidelink radio condition for the relay UE; services that the relay UE can relay; groups for which the relay UE can provide relay service; possible DNNs/S-NSSAIs for the relay service; serving PLMN for the relay UE; and whether the remote UE is preconfigured with the relay UE as a provider for the relay connection.

If it is determined, at 712, that the relay type is not supported, the operation flow/algorithmic structure 700 may advance to discarding the discovery message and monitoring for another at 720.

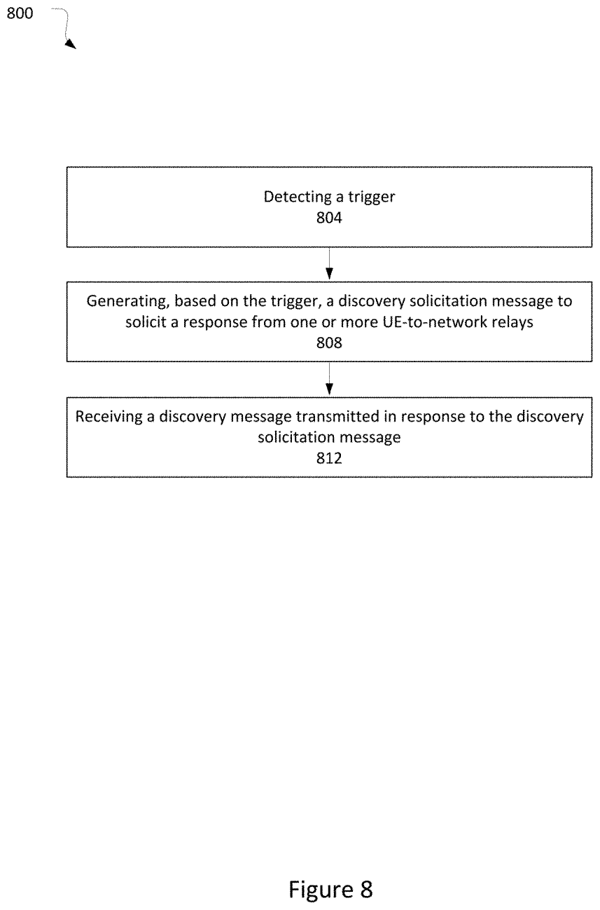

FIG. 8 illustrates an operation flow/algorithmic structure 800 in accordance with some aspects. The operation flow/algorithmic structure 800 may be performed or implemented by a remote UE such as, for example, remote UE 104 or 900; or components thereof, for example, baseband processor circuitry 904A.

The operation flow/algorithmic structure 800 may be based on, or otherwise similar to, a Model B UE-to-network discovery process.

The operation flow/algorithmic structure 800 may include, at 804, detecting a trigger. The trigger may be from an upper layer application or a user of the UE.

The operation flow/algorithmic structure 800 may further include, at 808, generating a discovery solicitation message to solicit a response from one or more UE-to-network relays. The generating of the discovery solicitation message may be based on the detection of the trigger.

The discovery solicitation message may be generated with relay related information that includes an indication of a relay-type that is supported or preferred by the implementing UE. For example, the indication may indicate that the implementing UE may connect with (or prefers to connect to) an L2 relay or an L3 relay. The indication may be one or two bits within a relay type IE of the discovery solicitation message. In some embodiments, the indication may indicate that the remote UE is capable of connecting with either an L2 or an L3 relay and the indication may further indicate whether the remote UE has a preference of connecting through the L2 or L3 relay.

In addition to the indication of the relay type, the relay related information in the discovery solicitation message may include service/application IDs or other information related to services and applications that are to be relayed; group index(es) or other information related to groups for which the relay service is to be provided; slicing information (for example, one or more allowed S-NSSAI) regarding network slices for which information is to be relayed; DNN information for DNN(s) corresponding to the relay service. The discovery solicitation message may also include a discoverer ProSe UE ID.

The operation flow/algorithmic structure 800 may further include, at 812, receiving a discovery message transmitted in response to the discovery solicitation message. In some embodiments, the discovery message may include a ProSe UE ID, service/application information, group index(es), S-NSSAI(s), DNN, HPLMN or VPLMN similar to that described above with respect to discovery message transmitted at 532. The discovery message may or may not include an indication of whether the relay UE is to operate as an L2 or L3 relay. By responding to the discovery solicitation message, the relay UE may be asserting that it is capable of providing the relay type indicated in the discovery solicitation message. However, in some instances, it may be advantageous to also include the indication. For example, if the remote UE is capable of connecting with an L2 or an L3 relay, but has a preference to connect with one over the other, it may be helpful to include the relay type indication in the responsive discovery message. In this case, if the remote UE receives multiple responsive discovery messages, it may prioritize connection with the relay UE of the desired relay type.

FIG. 9 illustrates a UE 900 in accordance with some aspects. The UE 900 may be similar to and substantially interchangeable with UEs 104 or 108.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices, proximity sensors, vehicle-based UEs, infrastructure-based UEs.

The UE 900 may include processors 904, RF interface circuitry 908, memory/storage 912, user interface 916, sensors 920, driver circuitry 922, power management integrated circuit (PMIC) 924, antenna 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 932, which may represent any type of interface, input/output, bus (local, system, or expansion), transmission line, trace, optical connection, etc. that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein.

In some aspects, the baseband processor circuitry 904A may access a communication protocol stack 936 in the memory/storage 912 to communicate over a 3GPP compatible network. In general, the baseband processor circuitry 904A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some aspects, the PHY layer operations may additionally/alternatively be performed by the components of the RF interface circuitry 908.

The baseband processor circuitry 904A may generate or process baseband signals or waveforms that carry information in 3GPP-compatible networks. In some aspects, the waveforms for NR may be based cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform various sidelink discovery operations described herein. The memory/storage 912 may also store relay related and relay support information as described elsewhere.

The memory/storage 912 include any type of volatile or non-volatile memory that may be distributed throughout the UE 900. In some aspects, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 908 may include transceiver circuitry and radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various aspects, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, phased array antennas, etc. The antenna 926 may have one or more panels designed for specific frequency bands including bands in frequency ranges 1 and 2.

The user interface 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 920 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 922 may include software and hardware elements that operate to control particular devices that are embedded in the UE 900, attached to the UE 190, or otherwise communicatively coupled with the UE 900. The driver circuitry 922 may include individual drivers allowing other components to interact with or control various input/output (I/O) devices that may be present within, or connected to, the UE 900. For example, driver circuitry 922 may include a display driver to control and allow access to a display device, a touchscreen driver to control and allow access to a touchscreen interface, sensor drivers to obtain sensor readings of sensors 920 and control and allow access to sensors 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

A battery 928 may power the UE 900, although in some examples the UE 900 may be mounted deployed in a fixed location, and may have a power supply coupled to an electrical grid. The battery 928 may be a lithium ion battery, a metal-air battery, such as a zinc-air battery, an aluminum-air battery, a lithium-air battery, and the like. In some implementations, such as in vehicle-based applications, the battery 928 may be a typical lead-acid automotive battery.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a UE, the method comprising: detecting a trigger; generating, based on the trigger, a sidelink direct discovery message to announce that the UE is capable of operating as a UE-to-network relay, the sidelink direct discovery message to include relay related information that has an indication of whether the UE is to operate as a layer-2 relay or a layer-3 relay; and transmitting the sidelink direct discovery message.

Example 2 includes the method of example 1 or some other example herein, wherein the sidelink direct discovery message is to include a relay type information element, IE, that includes the indication of whether the UE is to operate as a layer-2 relay or a layer-3 relay.

Example 3 includes the method of example 1 or some other example herein, wherein the sidelink direct discovery message is a model A direct discovery message.

Example 4 includes the method of example 1 or some other example herein, wherein the sidelink direct discovery message comprises a PC5 direct discovery message.

Example 5 includes the method of example 1 or some other example herein, wherein the relay related information further includes: service and application information that is enabled or authorized to be relayed; group information for which the UE can provide relay service; slicing information the UE is enabled or authorized to relay; data network name, DNN, information the UE is authorized to access; or a home public land mobile network, HPLMN, or visited public land mobile network, VPLMN, for the UE.

Example 6 includes a method of operating a UE, the method comprising: storing relay support information; receiving a discovery message from a UE-to-network relay; determining, based on the discovery message, a relay type of the UE-to-network relay; determining, based on the relay support information, whether the relay type is supported by the UE; and determining whether to select the UE-to-network relay for a relay connection based on whether the relay type is supported by the UE.

Example 7 includes the method of example 6 or some other example herein, further comprising: determining that the relay type is supported by the UE; and selecting the UE-to-network relay for the relay connection.

Example 8 includes the method of example 6 or some other example herein, further comprising: determining that the relay type is not supported by the UE; and discarding the discovery message and monitoring for another discovery message from another UE-to-network relay.

Example 9 includes the method of example 6 or some other example herein, wherein the discovery message includes an indication of the relay type.

Example 10 includes the method of example 9 or some other example herein, wherein the discovery message includes a relay type information element, IE, with the indication of the relay type.

Example 11 includes the method of example 6 or some other example herein, wherein the discovery message includes one or more parameters specific to the relay type, and the method further comprises determining the relay type of the UE-to-network relay based on presence of the one or more parameters in the discovery message.

Example 12 includes the method of example 11 or some other example herein, wherein the one or more parameters includes broadcast slicing information, DNN information, security information, or PDU session information.

Example 13 includes the method of example 12 or some other example herein, wherein the relay type comprises a layer-3 relay type.

Example 14 includes the method of example 6 or some other example herein, wherein the relay type comprises a layer-2 relay type or a layer-3 relay type.

Example 15 includes a method of operating a UE, the method comprising: detecting a trigger; generating, based on the trigger, a discovery solicitation message to solicit a response from one or more UE-to-network relays, the discovery solicitation message to include relay related information that has an indication of a relay type that is supported or preferred by the UE; and receiving, from a UE-to-network relay, a discovery message transmitted in response to the discovery solicitation message.

Example 16 includes the method of example 15 or some other example herein, wherein the discovery solicitation message is to include a relay type information element, IE, that includes the indication of the relay type.

Example 17 includes the method of example 15 or some other example herein, wherein the discovery solicitation message is a model B direct discovery message.

Example 18 includes the method of example 15 or some other example herein, wherein the indication is to indicate that the UE supports a plurality of relay types.

Example 19 includes the method of example 15 or some other example herein, wherein the indication is to indicate the UE supports or prefers a layer-2 relay type or a layer-3 relay type.

Example 20 includes the method of example 15 or some other example herein, wherein the relay related information further includes: service and application information that is enabled or authorized to be relayed; group or slicing information for which relay service is requested; or data network name, DNN, information.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1. One or more non-transitory computer-readable media having instructions that, when executed, cause a user equipment, UE, to:
detect a trigger;
generate, based on the trigger, a sidelink direct discovery message to announce that the UE is capable of operating as a UE-to-network relay, the sidelink direct discovery message to include relay related information that has an indication of whether the UE is to operate as a layer-2 relay or a layer-3 relay; and
transmit the sidelink direct discovery message.

2. The one or more non-transitory computer-readable media of claim 1, wherein the sidelink direct discovery message is to include a relay type information element, IE, that includes the indication of whether the UE is to operate as a layer-2 relay or a layer-3 relay.

3. The one or more non-transitory computer-readable media of claim 1, wherein the sidelink direct discovery message is a model A direct discovery message.

4. The one or more non-transitory computer-readable media of claim 1, wherein the sidelink direct discovery message comprises a PC5 direct discovery message.

5. The one or more non-transitory computer-readable media of claim 1, wherein the relay related information further includes: service and application information that is enabled or authorized to be relayed; group information for which the UE can provide relay service; slicing information the UE is enabled or authorized to relay; data network name, DNN, information the UE is authorized to access; or a home public land mobile network, HPLMN, or visited public land mobile network, VPLMN, for the UE.

6. A user equipment, UE, comprising:
memory to store relay support information; and
processing circuitry, coupled with the memory, the processing circuitry to:
receive a discovery message from a UE-to-network relay;
determine, based on the discovery message, a relay type of the UE-to-network relay;
determine, based on the relay support information, whether the relay type is supported by the UE; and
determine whether to select the UE-to-network relay for a relay connection based on whether the relay type is supported by the UE.

7. The UE of claim 6, wherein the processing circuitry is to:
determine that the relay type is supported by the UE; and
select the UE-to-network relay for the relay connection.

8. The UE of claim 6, wherein the processing circuitry is to:
determine that the relay type is not supported by the UE; and
discard the discovery message and monitor for another discovery message from another UE-to-network relay.

9. The UE of claim 6, wherein the discovery message includes an indication of the relay type.

10. The UE of claim 9, wherein the discovery message includes a relay type information element, IE, with the indication of the relay type.

11. The UE of claim 6, wherein the discovery message includes one or more parameters specific to the relay type, and the processing circuitry is to determine the relay type of the UE-to-network relay based on presence of the one or more parameters in the discovery message.

12. The UE of claim 11, wherein the one or more parameters includes broadcast slicing information, DNN information, security information, or PDU session information.

13. The UE of claim 12, wherein the relay type comprises a layer-3 relay type.

14. The UE of claim 6, wherein the relay type comprises a layer-2 relay type or a layer-3 relay type.

15. A method of operating a user equipment, UE, the method comprising:
detecting a trigger;
generating, based on the trigger, a discovery solicitation message to solicit a response from one or more UE-to-network relays, the discovery solicitation message to include relay related information that has an indication of a relay type that is supported or preferred by the UE; and
receiving, from a UE-to-network relay, a discovery message transmitted in response to the discovery solicitation message.

16. The method of claim 15, wherein the discovery solicitation message is to include a relay type information element, IE, that includes the indication of the relay type.

17. The method of claim 15, wherein the discovery solicitation message is a model B direct discovery message.

18. The method of claim 15, wherein the indication is to indicate that the UE supports a plurality of relay types.

19. The method of claim 15, wherein the indication is to indicate the UE supports or prefers a layer-2 relay type or a layer-3 relay type.

20. The method of claim 15, wherein the relay related information further includes: service and application information that is enabled or authorized to be relayed; group or slicing information for which relay service is requested; or data network name, DNN, information.
